(19) United States
(12) Patent Application Publication
(10) Pub. No.: US 2007/0051679 A1
(43) Pub. Date: Mar. 8, 2007

(54) Water filtration using immersed membranes

(76) Inventors: Nicholas William Harcsar Adams, Hamilton (CA); Manwinder Singh, Burlington (CA); Fraser Charles Kent, Milton (CA); Pierre Lucien Cote, Dundas (CA); David Brian Ross, Burlington (CA); Kevin Simon Joseph Dufresne, Dundas (CA)

Correspondence Address: BERESKIN AND PARR, 40 KING STREET WEST, BOX 401, TORONTO, ON, M5H 3Y2, CA

(21) Appl. No.: 11/508,983

(22) Filed: Aug. 24, 2006

Related U.S. Application Data
(63) Continuation of application No. PCT/CA05/00282, filed on Feb. 25, 2005.
Application No. PCT/CA05/00282 is a continuation-in-part of application No. 10/961,077, filed on Oct. 12, 2004.
(60) Provisional application No. 60/547,787, filed on Feb. 27, 2004.
(60) Provisional application No. 60/575,804, filed on Jun. 2, 2004.

(30) Foreign Application Priority Data
Sep. 24, 2004 (CA) 2,482,517

(51) Int. Cl. B01D 65/02

(52) U.S. Cl. 210/636; 210/321.6; 210/321.69

(57) ABSTRACT

A process and apparatus is described for filtering water with immersed membranes. In a batch process, permeate is withdrawn while the flow of feed is reduced or stopped at the end of a permeation cycle. The water level is reduced to a level where a portion of the membranes are exposed to air before draining the tank. In this or another process, the level of liquid is reduced to correspond with an area of the membrane fibers having an accumulation of solids. Aeration is provided for a period of time with the liquid at this level to dislodge at least a portion of the solids from the membranes. In these or other processes, the tank is partially drained between cycles to deconcentrate the tank, aeration is provided during backwashing and intermittently while permeating, and/or retentate is withdrawn from the tank during a portion of a permeation step.

This is a continuation of International Patent Application No. PCT/CA2005/000282 filed Feb. 25, 2005, which is a continuation-in-part of U.S. application Ser. No. 10/961,077 filed Oct. 12, 2004 and claims the benefit of U.S. Application Ser. Nos. 60/547,787, 60/575,804 and 60/633,432 filed on Feb. 27, 2004, Jun. 2, 2004 and Dec. 7, 2004, respectively. All of the applications mentioned above are incorporated herein, in their entirety, by this reference to them.

### FIELD OF THE INVENTION

This invention relates to water filtration using immersed membranes.

### BACKGROUND OF THE INVENTION

The following discussion of the background of the invention is not an admission that any information discussed therein is citable as prior art or part of the knowledge of persons skilled in the art in any country.

Immersed membranes are filtering membranes that may be immersed in a liquid, for example water, held at ambient pressure during permeation. Filtered water, or permeate, is withdrawn through the membranes by applying a transmembrane pressure differential caused by applying a suction, for example by a pump or siphon, to a permeate side of the membranes or a liquid head, for example as caused by the membranes being immersed to some depth in the liquid, to a feed or retentate side of the membranes, or both. Multiple membranes are typically collected into various units which may be called, for example, modules or cassettes. The membranes may be in various configurations, for example flat sheet or hollow fibers. Examples of flat sheet membrane units are described in U.S. Pat. No. 5,192,456. Examples of hollow fiber membrane units are described in U.S. Pat. No. 5,639,373, U.S. Pat. No. 6,790,360, U.S. Pat. No. 6,555,005 and U.S. Pat. No. 6,325,928.

In water filtration, the membranes are used to separate a feed water into permeate and retentate streams. Sample applications include filtering ground or surface water to provide drinking water and filtering wastewater plant effluent to improve its quality before discharge. While some biological activity may occur in the feed water, biological treatment of the feed is not a primary concern as in wastewater treatment. The feed water in water filtration also tends to have a lower solids content than for wastewater treatment. For example, the feed water may have a total suspended solids content ranging from 0.005 g/L or less up to about 0.1 g/L. Flocculation or other chemical or biological pretreatments may be used to increase the filterability of the feed water and may result in feed flowing from a flocculation tank to a membrane tank having a solids content (TSS) of up to about 0.2 g/L. Some pretreatments may not be suitable for use with batch processes in which the tank is periodically drained completely because chemicals may be wasted before they are fully used or because the concentration of the chemicals must be kept within a narrower range.

An example of a water filtration process is described in U.S. Pat. No. 6,156,200. In this process, 30 minute suction periods with the tank full are each followed by backwash and air scrubbing steps. After every 3 to 10 suction periods, the tank is drained completely and refilled.

Other examples of a water filtration processes are described in U.S. Pat. No. 6,303,035. In one process, a filtration cycle comprises steps of filling a tank to a level above the membranes, withdrawing permeate through the membranes while the water in the tank is above the membranes, then aerating the membranes to dislodge solids from the membranes and then backwashing the membranes while draining the tank.

Another example of a water filtration process is described in International Publication No. WO01/36075. Membrane modules are arranged to substantially cover the cross-sectional area of a tank. A filtration cycle has permeation steps followed by deconcentration steps. During permeation, the supply of feed substantially equals permeate removed. During deconcention, aeration with scouring bubbles is provided with one or both of backwashing and feed supply from below the modules. Excess tank water flows generally upwards through the modules and out through an overflow at the top of the tank.

Other sample processes are described in U.S. Pat. No. 6,375,848. One process proceeds as a number of repeated cycles. The cycle begins with membranes submerged in tank water. Permeate is pumped through the membranes while feed is added at the rate of permeate withdrawal to keep the membranes immersed. After permeation for between 2 and 5 hours, drain valves in the tank are opened and the rate of feed flow is correspondingly increased to keep the membranes immersed and permeation continues. The drain is kept open for up to 25 minutes and between 100 and 300% of the tank volume is discharged. When the concentration of solids in the tank water is decreased by at least 60%, the drain valves are closed and a new cycle begins. In another process described in the same patent, membrane modules are immersed in a tank. Feed water continuously enters the tank to keep the membranes immersed. Permeate continuously exits the tank through the modules but for periods when the membranes are backwashed. Tank water continuously flows out of the tank via a drain but at a rate of only up to 20% of the feed flow rate. The membranes are continuously aerated to clean the membranes and mix the water in the tank.

Performance of a water filtration system may be measured by one or more of various parameters depending on the specific application. One parameter which may be considered is recovery rate, meaning the ratio of permeate produced per unit volume of feed water. A higher recovery rate provides a lower volume of retentate which must be discharged or treated further. Another parameter which may be considered is the energy cost of aeration. Many immersed membrane systems use aeration, or air scouring, to inhibit membrane fouling. The energy required to aerate the membrane units is a significant annual expense and a significant component of the life cycle cost of a membrane system. Another parameter which may be considered is the fouling rate of the membranes. The rate at which the membranes foul effects how long a membrane unit will last before it needs to be replaced and the amount of chemical cleaning or aeration that may be required to keep the unit operating at an acceptable permeability or flux. Membrane fouling is related to many factors including the effectiveness of aeration and backwashing and the concentration of solids in the liquid on the feed or retentate side of the membranes. There is a need to provide water filtration systems that perform well according to one or more of these parameters.

### SUMMARY OF THE INVENTION

It is an object of the invention to improve on, or at least provide a useful alternative to, the prior art. It is another object of the invention to provide a process or apparatus for filtering water using immersed membranes. Such a process or apparatus may provide improvements in one or more of recovery rate, aeration energy cost or membrane fouling rate. The following summary is intended to introduce the reader to the invention but not to define the invention which may reside in a combination or subcombination of apparatus elements or process steps described in this or other parts of this documents, for example the claims.

In one aspect, this invention relates to a method for backwashing immersed membranes that reduces the volume of water discharged per backwash or deconcentration. For immersed membrane systems operated in a batch mode, where water is discharged periodically by draining the membrane tank, there is a relationship between filtration cycle time (time between tank drain events) and volume of discharged water.

$${t}_{F} = {V}_{BW} \times \frac{R}{{Q}_{F} ( 1 - R )}$$

Where:
t_{F}=Filtration cycle time
V_{BW}=Volume of discharged water
Q_{F}=(Average) Net filtration flow rate
R=Recovery (Filtrate/Feed)

By minimizing the volume of discharged water, the filtration cycle time can be reduced while maintaining the same system recovery. A shorter filtration cycle time leads to improved membrane performance by reducing membrane fouling (since the membranes operate in water of a lower solids concentration on average if a new cycle starts with highly deconcentrate tank water) and therefore allowing the membrane system to be designed and operated at higher fluxes. Alternatively, the reduced volume of discharged water will allow membrane systems to be operated at higher system recovery without impacting on the filtration cycle time and membrane performance. The volume of discharged water may equal or be less than the tank volume even though the tank may be drained to be fully empty between cycles and the membranes may be backwashed by flowing permeate back into the tank prior to draining the tank.

In another aspect, the invention relates to a batch membrane filtration process having a permeate down step prior to backwash or tank drain steps. The process begins by filling the tank and then permeating while adding feed to preserve a generally constant water level above the membranes in the tank. After this step, the water level in the membrane tank is lowered to a reduced level in the permeate down step which involves reducing or stopping feed to the membrane tank but continuing permeation to lower the water level in the membrane tank. The level can be lowered even to the point where a portion of the membranes are exposed to air. The membrane system is then backwashed to dislodge solids from within the membrane pores and from the membrane surface. Optionally, the reduced level in the membrane tank may be such that backpulsing will completely re-immerse the membrane fibers or such that a portion of the membranes remains exposed to air. After the backwash, the membrane tank may be drained. Alternately, a second permeate down step may be used to lower the water level again before draining the tank. The membranes may be backwashed before or after the water level have been lowered. With or without the second permeate down step, a portion of the membranes may be exposed to air when the tank drain starts. The membrane fibers may also be air scoured during one or more of the permeate down step or steps, the backwashing step, the tank drain step or before or between any of these steps. Some of the steps may also overlap with other steps.

In another aspect, the invention relates to a process for improving the effectiveness of aeration to inhibit fouling of the membranes. The inventors have observed that, despite regular backwashing, aeration or chemical cleaning, solids or sludge may still accumulate around the membrane fibers. In particular, sludge may build up in a layer above a lower header of a module of vertical fibers, in a layer below an upper header, or in other areas of these or other types of modules that are difficult to contact with bubbles under ordinary air scouring. A process for reducing the accumulation of sludge build-up on membrane fibers immersed in a liquid includes reducing the level of the liquid to or near an area of the membranes having an accumulation of sludge and providing air scouring for a period of time with the liquid surface at this level in order to dislodge sludge or solids from the membrane fibers. While the invention is not limited to this theory, the inventors believe that energy released by the bubbles bursting at the lowered water surface is highly effective at removing sludge or solids build ups from problem areas in a module. The sludge may be removed from the membrane tank directly thereafter by draining the rest of the tank, or removed later, for example after the tank has been refilled.

In another aspect, an alternative is provided to aerating a membrane unit, particularly an element of vertical hollow fibers extending between upper and lower headers, or extending downwards from a single header. A membrane unit is typically aerated with the tank filled to at or above the top of the unit. Instead, the tank water level is reduced to and held at a level near, but below an upper header or other structure that would restrict vertically upwards flow through the unit, for example from 1 to 10 cm or 2 to 6 cm below the bottom of an upper header, while the element is aerated. This helps prevent damage to the membranes that might result from energy dissipation as rising air bubbles hit the bottom of the top header and move sideways to escape out of the module. However, energy released at the surface of the tank water still cleans the upper area of the membranes.

In some embodiments the process described above is combined with steps for the operation of a filtering system, for example one having a cycle of permeation and deconcentration.

In other aspects, the invention provides various other filtration processes. The filtration processes may be used, for example, in new plants or as a retrofit for existing plants such as feed and bleed plants with continuous aeration. After retrofitting an existing feed and bleed plant with continuous aeration, the process may reduce the amount of aeration required at an acceptable cost to implement the changes. For example, an existing feed and bleed plant may not be set up to provide for rapid draining of large volumes of water. Accordingly, the cost of converting such a plant to drain the tank to empty while permeation is stopped may be prohibitive. Even in newly constructed plants, draining the entire volume of the tank between permeation steps adds to the cost of a plant and may also interfere with or prohibit the use of some desirable pre-treatment methods. Accordingly, processes are describes in which the tank is not drained to empty between permeation steps.

In one aspect, the invention provides a cyclical process in which, after a permeation period in which little or no retentate leaves the tank, the membranes are backpulsed and aerated. After the backpulsing, a portion of the tank, for example about 10-25% of the tank, is drained. Aeration may continue during this partial drain and remains useful because a substantial portion, for example 75% or more, of the membranes remain immersed. In the case of vertically oriented hollow fibers, the lower part of the module may foul more rapidly and aeration of this part of the module is not effected by the partial drain. After the partial drain, the tank is refilled and permeation begins in the next cycle.

In another aspect, the invention provides a process having a generally continuous reject bleed. Permeation is also generally continuous, but is stopped periodically, for example for backwashing. Aeration is provided during this backwash and intermittently between backwashes. The intermittent aeration reduces the amount of air used compared to a continuously aerated process.

In another aspect, the invention provides a cyclical process in which permeation is generally continuous but for periodic backwashing. Aeration is provided during the backwash and may continue for a period of time after the backwash. Retentate flow from the tank is provided during the backwash and may continue beyond the backwash and aeration steps, for example for one quarter or one third of the cycle duration, but for less than the entire cycle duration, for example two thirds or one half of the cycle duration or less. The timing of the retentate flow coincides with a period when solids, released from the membranes by the aeration and backwashing, are dispersed in the tank water and more likely to be removed in higher concentration in the retentate flow. The volume of retentate removed in each cycle provides a desired recovery rate and may be less than the tank volume, for example less than 50% of a tank volume or between 5-30% or 5-20% of the tank volume.

By any of the processes described above, filtration cycle times may be 45 or 40 minutes or less, 30 minutes or less or 20 minutes or less. The recovery rate may be at least 80% or at least 90% or between 90% and 95%. Filtration flow rate is a function of membrane flux and surface area. Membrane flux may be 40 L/m²/h or more or 50 L/m²/h or more or 60 L/m²/h or more. Membrane surface area may be 250 m² or 350 m² or more, or 750 m² or less for each gross cubic meter of tank volume. Tank volume is measured at a reference or design water level which may be when the tank is just full with the tank water at about the level of the top of the membrane units. The amount of water withdrawn as permeate may be between 5 and 70 tank volumes per hour or between 6 and 40 tank volumes per hour. Tank retention time, the time needed to remove one tank volume as permeate, may be between 1.5 and 10 minutes, or between 5 and 10 minutes for processes filtering medium or high solids level feeds or between 1.5 and 7.5 minutes for processes filtering low or medium solids level feeds. The process may be non-recirculating. The amount of permeate re-entering a tank during a backwash may be between 10% and 40% or 50%, or between 20% and 30% of the tank volume. For process calculations involving tank volume, for example calculations relating to volumes of retentate or permeate removed or backwash water returned in relation to tank volume, tank retention times, and related calculations, the volume occupied by the membrane units themselves is subtracted from the gross tank volume. Cycle times, rates of permeate removal and amount of retentate removed are related and may be chosen to produce a desired recovery rate.

In other aspects, the invention relates to a process in which a membrane unit is aerated during a tank filling step.

In other aspects, the invention provides all possible combinations of any two or more aspects described above. Other aspects of the invention may become apparent from the following description of exemplary embodiments or the claims.

### BRIEF DESCRIPTION OF THE DRAWINGS

Embodiments of the invention will now be described with reference to the following figures.

FIG. 1 is a schematic diagram of a filtration apparatus.

FIGS. 2, 3 and 4 are representations of various membrane cassettes.

FIG. 5 is a flow diagram of a process according to an embodiment of the invention.

FIGS. 6 and 7 shown side and plan views of another apparatus.

FIG. 8 is a flow diagram of another process according to an embodiment of the invention;

FIG. 9 is a flow diagram of another process according to another embodiment of the invention;

FIG. 10 is a schematic diagram of a membrane tank, at the start of the process illustrated in FIG. 8;

FIG. 11 is a schematic diagram of the membrane tank shown in FIG. 10, at a later step in the process illustrated in FIG. 8; and

FIG. 12 is a schematic diagram of a membrane tank, at a step in the process illustrated in FIG. 9.

FIGS. 13, 14 and 15 are diagrams of processes according to other embodiments of the invention.

### DETAILED DESCRIPTION OF THE INVENTION

The general description of membrane units, filtration apparatus elements and of general batch and feed and bleed processes below applies to the other embodiments described further below to the extent that the general description is not inconsistent with the description of any particular embodiment.

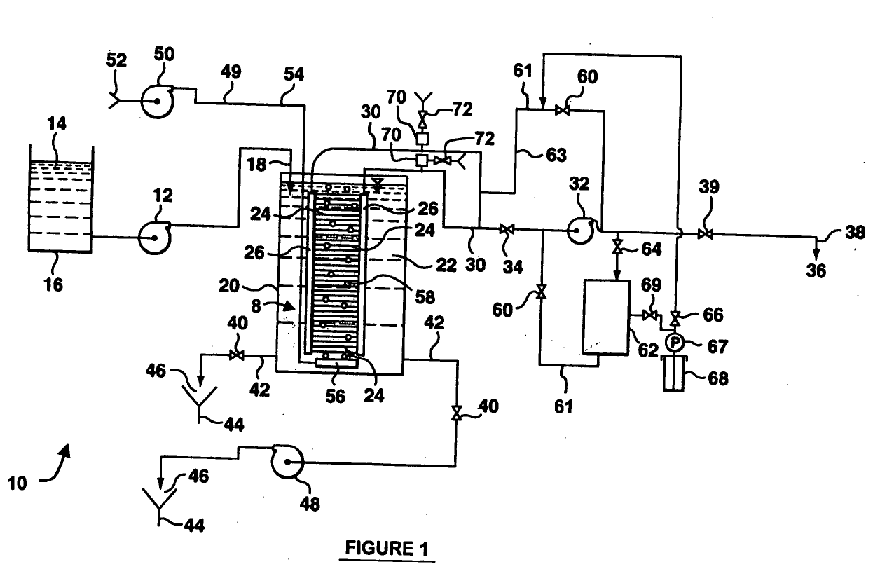

Referring now to FIGS. 1 to 4, a reactor 10 is shown for treating a liquid feed having solids to produce a filtered permeate with a reduced concentration of solids and a retentate with an increased concentration of solids. Such a reactor 10 has many potential applications and may be used, for example, for creating potable, municipal or residential water from a supply of water such as a lake, well, or reservoir, for tertiary filtration of wastewater, or for filtering industrial process water. Such a water supply typically contains colloids, suspended solids, bacteria and other particles or substances which must be filtered out and will be collectively referred to as solids whether solid or not. The reactor 10 may be modified in various ways, including providing pre or post treatment stages. The description below is intended to introduce sample systems that may be used with the invention and not to limit the invention to a particular reactor.

The first reactor 10 includes a feed pump 12 which pumps feed water 14 to be treated from a water supply 16 through an inlet 18 to a tank 20 where it becomes tank water 22. Alternatively, a gravity feed may be used with feed pump 12 replaced by a feed valve. Each membrane 24 has a permeate side which does not contact the tank water 22 and which is not visible because it is inside the membrane 24, and a retentate side which does contact the tank water 22. The membranes 24 may be hollow fibre membranes 24 for which the outer surface of the membranes 24 is the retentate side and the lumens of the membranes 24 are the permeate side.

The membranes 24 are connected into an element 8. The element 8 shown is an example of a type of membrane unit that may be used, although other membrane units may also be used with the invention. In the element 8, each membrane 24 is attached to one or more headers 26. Each header 26 may either secure a closed end or loop of the membranes 24, or may secure an open end of the membrane 24 and facilitate connecting the open ends of the membrane 24 to a permeate collection channel. Open ends of the membrane 24 are surrounded by a potting material to produce a watertight connection between the outside of the membranes 24 and the headers 26 while keeping the permeate side of the membranes 24 in fluid communication with a permeate channel in at least one header 26. The permeate channels of the headers 26 are connected to a permeate collector 30 and a permeate pump 32 through a permeate valve 34. Air entrained in the flow of permeate through the permeate collectors 30 becomes trapped in air collectors 70, typically located at at least a local high point in a permeate collector 30. The air collectors 70 are periodically emptied of air through air collector valves 72 which may, for example, be opened to vent air to the atmosphere when the membranes 24 are backwashed or have a pump to extract the air. Filtered permeate 36 is produced for use at a permeate outlet 38 through an outlet valve 39. Periodically, a storage tank valve 64 may be opened to admit permeate 36 to a storage tank 62. The filtered permeate 36 may require post treatment before being used as drinking water, but should have acceptable levels of colloids and other suspended solids.

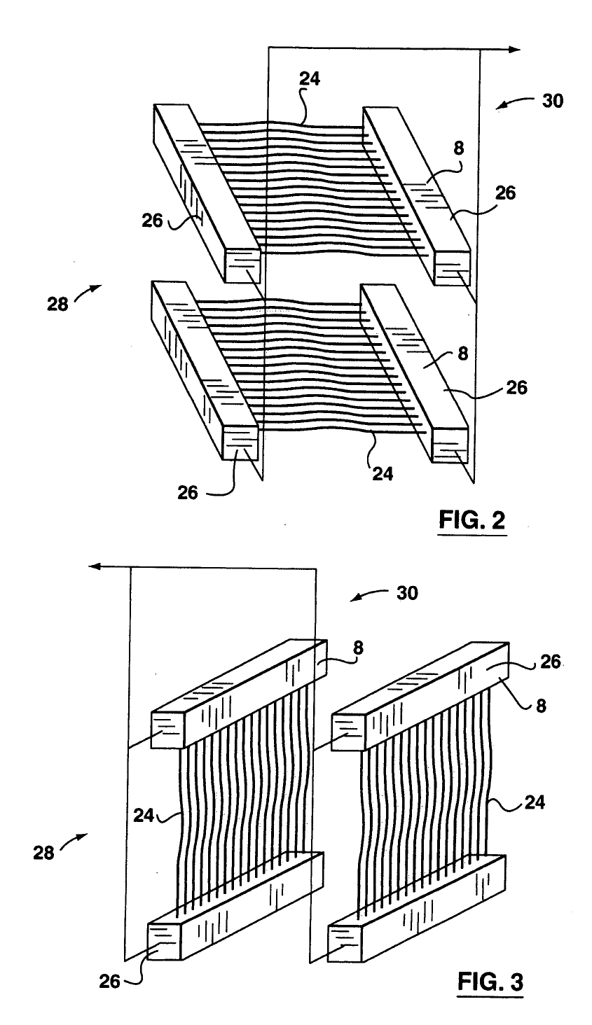

In a large reactor 10, a plurality of elements 8 may be assembled together into cassettes 28 and the cassettes 28 may be connected together into or other larger membrane units. There may be multiple permeate collectors 30, permeate pumps 32 or other components. Examples of cassettes 28 are shown schematically in FIGS. 2, 3 and 4. Each element 8 of the type illustrated may have one or more bunches between 1 cm and 10 cm wide of hollow fibre membranes 24. Other sorts of elements 8 and cassettes 28 or other membrane units may also be used. The membranes 24 may have an average pore size in the microfiltration or ultrafiltration range, for example between 0.003 microns and 10 microns or between 0.02 microns and 1 micron. The elements 8 may also have only one permeating header 26, in which case there are no permeate lines to the other header 26. The headers 26 may also have openings to permit water or air to flow through a header 26

Referring to FIG. 3, for example, a plurality of elements 8 are connected to a common permeate collector 30. The membranes 24, are oriented vertically in a vertical plane. Depending on the length of the membranes 24 and the depth of the tank 20, multiple cassettes 28 as shown in FIG. 3 may also be stacked one above the other. Referring to FIGS. 2 and 4, the elements 8 are shown in alternate orientations. In FIG. 2, the membranes 24 are oriented in a horizontal plane and the permeate collector 30 is attached to a plurality of elements 8 stacked one above the other. In FIG. 4, the membranes 24 are oriented horizontally in a vertical plane. Depending on the depth of the headers 26 in FIG. 4, the permeate collector 30 may also be attached to a plurality of these cassettes 28 stacked one above the other. The representations of the cassettes 28 in FIGS. 2, 3, and 4 have been simplified for clarity, actual cassettes 28 typically having elements 8 much closer together, more elements 8, and a frame to hold them together.

Cassettes 28 or other membrane units can be created with elements 8 of different shapes, for example cylindrical, and with bunches of looped fibres attached to a single header 26 or fibers held in a header 26 at one end and loose at the other. Similar modules, units or cassettes 28 can also be created with tubular membranes in place of the hollow fibre membranes 24. For flat sheet membranes 24, pairs of membranes 24 may be attached to headers or casings that create an enclosed surface between the membranes and allow appropriate piping to be connected to the interior of the enclosed surface. Several of these units can be attached together to form a cassette of flat sheet membranes. Commercially available cassettes 28 of hollow fiber membranes include those made by ZENON Environmental Inc. and sold under the ZEE WEED™, for example, as ZEE WEED 500 or ZEE WEED 1000 products.

To provide chemical cleaning from time to time, a cleaning chemical such as sodium hypochlorite, sodium hydroxide or citric acid is provided in a chemical tank 68. Permeate valve 34, outlet valve 39 and backwash valves 60 are all closed while a chemical backwash valve 66 is opened. A chemical pump 67 is operated to push the cleaning chemical through a chemical backwash pipe 69 and then in a reverse direction through permeate collectors 30 and the walls of the membranes 24. At the end of the chemical cleaning, chemical pump 67 is turned off and chemical pump 66 is closed. Preferably, the chemical cleaning is followed by a permeate backwash to clear the permeate collectors 30 and membranes 24 of cleaning chemical before permeation resumes. Chemical cleaning can also be provided by filling the tank 20 with a chemical solution and sucking it through the membranes 24.

To fill the tank 20, a feed pump 12 pumps feed water 14 from the water supply 16 through the inlet 18 to the tank 20 where it becomes tank water 22. The tank 20 is full when the level of the tank water 22 first completely covers the membranes 24 in the tank 20 but the tank 20 may also have tank water 22 above this level at various times and may be operated with a design water level above the tank full level.

To permeate, the permeate valve 34 and an outlet valve 39 are opened and the permeate pump 32 is turned on. A negative pressure is created on the permeate side of the membranes 24 relative to the tank water 22 surrounding the membranes 24. The resulting transmembrane pressure, which may be between 1 kPa and 100 kPa, or between 20 kPa and 85 kPa, draws tank water 22 (then referred to as permeate 36) through the membranes 24 while the membranes 24 reject solids which remain in the tank water 22. Thus, filtered permeate 36 is produced for use at the permeate outlet 38. Periodically, a storage tank valve 64 is opened to admit permeate 36 to a storage tank 62 for use in backwashing. As filtered permeate 36 is removed from the tank, the feed pump 12 may be operated, during some or all of the permeation period, to keep the tank water 22 at a level which covers the membranes 24, for example the tank full level or the design level, accounting for retentate removal during permeation, if any, or removal of foam or other substances, if any.

To backwash the membranes, alternately called backpulsing or backflushing, with permeation stopped, backwash valves 60 and storage tank valve 64 are opened. Permeate pump 32 is turned on to push filtered permeate 36 from storage tank 62 through a backwash pipe 63 to the headers 26 and through the walls of the membranes 24 in a reverse direction thus pushing away some of the solids attached to the membranes 24. The volume of water pumped through the walls of a set of the membranes 24 in the backwash may be between 10% and 40%, more often between 20% and 30%, of the volume of the tank 20 holding the membranes 24. At the end of the backwash, backwash valves 60 are closed. As an alternative to using the permeate pump 32 to drive the backwash, a separate pump can also be provided in the backwash line 63 which may then by-pass the permeate pump 32. By either means, the backwashing may continue for between 15 seconds and one minute. When the backwash is over, permeate pump 32 is then turned off and backwash valves 60 closed. The flux during backwashing may be 1 to 3 times the permeate flux and may be provided continuously, intermittently or in pulses.

To provide scouring air, alternately called aeration, the air supply pump 50 is turned on and blows air, nitrogen or other appropriate gas from the air intake 52 through air distribution pipes 54 to the aerators 56 located below, between or integral with the membrane elements 8 or cassettes 28 and disperses air bubbles 58 into the tank water 22 which flow upwards past the membranes 24.

The amount of air scouring to provide is dependant on numerous factors but is preferably related to the superficial velocity of air flow through the aerators 56. The superficial velocity of air flow is defined as the rate of air flow to the aerators 56 at standard conditions (1 atmosphere and 25 degrees Celsius) divided by the cross sectional area effectively scoured by the aerators 56. Scouring air may be provided by operating the air supply pump 50 to produce air corresponding to a superficial velocity of air flow between 0.005 m/s and 0.15 m/s. At the end of an air scouring step, the air supply pump 50 is turned off. Although air scouring is most effective while the membranes 24 are completely immersed in tank water 22, it is still useful while a portion of the membranes 24 are exposed to air. Air scouring may be more effective when combined with backwashing.

Air scouring may also be provided at times to disperse the solids in the tank water 22 near the membranes 24. This air scouring prevents the tank water 22 adjacent the membranes 24 from becoming overly rich in solids as permeate is withdrawn through the membranes 24. For this air scouring, air may be provided continuously at a superficial velocity of air flow between 0.0005 m/s and 0.015 m/s or intermittently, for example for 5 to 180 seconds every 1 to 15 minutes or for 5 to 20 seconds every 1 to 4 minutes, at a superficial velocity of air flow between 0.005 m/s and 0.15 m/s.

To remove unfiltered tank water 22 from the tank 20, which may be called draining, rejection, reject removal or bleed depending on the speed and extend of tank water 22 removal, the drain valves 40 are opened to allow tank water 22, then containing an increased concentration of solids and called retentate 46, to flow from the tank 20 through a retentate outlet 42 to a drain 44 or further processing area. The retentate pump 48 may be turned on to drain the tank more quickly, but in many installations the tank will empty rapidly enough by gravity alone, particularly where a reject bleed is desired during permeation. It may take between two and ten minutes to drain the tank 20 completely from full and less time to partially drain the tank 20. Retentate 46 may also be removed from the tank 20 by overflow from the top of the tank 20 or by pipes or other conduits at intermediate elevations.

In filtration processes in general, tank water 22 may be recirculated with other tanks or reservoirs. Alternately, substantially all feed water 14 entering a tank 20 may leave the tank 20 as either permeate 36 or retentate 46, with the retentate 46 not returning to the tank 20. For the purposes of this document, processes in which substantially all feed water 14 entering the tank 20 leaves the tank 20 as either permeate 36 or retentate 46 that will not return to the tank 20, by either batch, feed and bleed or another process, will be referred to as non-recirculating processes. If the retentate 46 will not be filtered further, the non-recirculating process may also be referred to as a single pass process. If the retentate 46 will be filtered again in a downstream reactor, but still not return to the tank 20, the process may also be referred to as the first pass of a multiple pass system. Processes in which a substantial portion of the unfiltered tank water 22 is removed from the tank 20 and flows back to the water supply 16, or through some other passage that brings some or all of the removed tank water 22 back to the tank 20, will be called recirculating processes. All of the embodiments described below are non-recirculating processes unless stated otherwise. However, various aspects of the invention may also be applied to recirculating processes, particularly those with recirculation of feed water 22 between a tank 20 and water supply 16 of similar volumes. A period in a process during which feed water 14 enters a tank 20 and only permeate 36 leaves the tank 20 may be referred to as a period of dead end filtration. A process having a period of dead end filtration may be referred to as a dead end process even though in other periods, such as a deconcentration, retentate 46 may also leave the tank 20. For the purposes of this document, a cyclical process having a substantial period of time in which permeate 36 is withdrawn but no retentate 46 is withdrawn and another, shorter, period of time in which retentate 46 is withdrawn but no permeate 36 is withdrawn, may be called a batch or non-continuous process. During the period in which permeate 36 is withdrawn, there may be dead end filtration or recirculating permeation but for the purposes of this document, a batch process will be assumed to have a period of dead end permeation unless stated otherwise.

An example of a non-recirculating batch filtration process may have a repeated cycle of concentration, or permeation, and deconcentration steps. During the concentration step, permeate is withdrawn from a fresh batch of tank water 22 initially having a low concentration of solids. For example, if the tank 20 has been drained and refilled completely, then tank water 22 initially has a concentration of solids like the feed water 14. As the permeate is withdrawn, fresh feed water 14 is introduced to replace the water withdrawn as permeate 36. During this step, which may last from 10 minutes to 4 hours, or from 15 to 40 or 45 minutes, solids are rejected by the membranes 24 and do not flow out of the tank 20 with the permeate 36. In a single pass process, there may be no flow of retentate 46 or other removal or recirculation of tank water 22. As a result, the concentration of solids in the tank increases, for example to between 2 and 100, or 5 to 50, times the concentration of the feed water 14. The process then proceeds to the deconcentration step. In the deconcentration step, which may be between 1/50 and ⅕ the duration of the concentration step, a large quantity of solids are rapidly removed from the tank 20 by removing unfiltered tank water 22 to return the solids concentration back to the initial concentration. This may be done by draining a portion the tank 20 and refilling it with new feed water 14. To help move solids away from the membranes 24 themselves, air scouring and backwashing may be used before or during the deconcentration step. A new cycle usually begins at the end of the preceding deconcentration. Some cycles, however, begin when a new reactor 10 is first put into operation or after chemical cleaning or other maintenance procedures.

An alternate process is a non-recirculating feed and bleed or continuous process. In an example of a feed and bleed process, feed water 14 flows generally continuously into the tank 20. Permeate 36 is withdrawn generally continuously, but may be stopped from time to time for example for backwashing. Retentate 46 is generally continuously bled out of the tank and, in a single pass process, does not return to the tank 20. The average flow rate of retentate 46 may be 1-20% of the feed water 14 flow rate. The remainder of the feed water 14 may be removed as permeate 36. The solids concentration in the tank water 22 reaches a level that may be 5 to 20 times above that of the feed water 14. Aeration may be provided continuously during permeation.

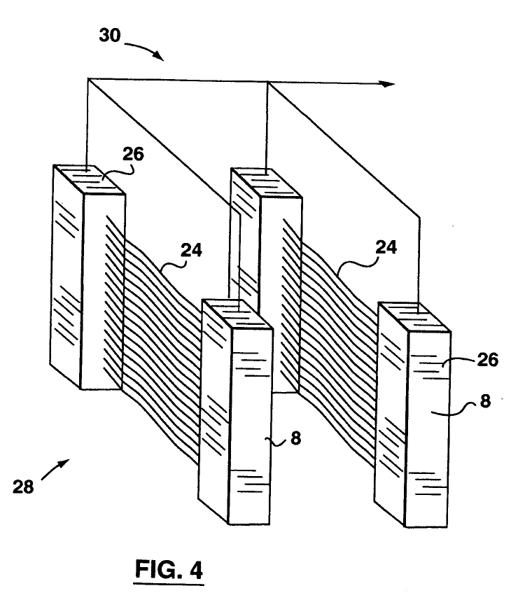

Referring now to FIG. 5, a filtration process for filtering water with immersed membranes has a filling step 100, a balanced permeation step 102, a permeate down step 104, a backwash step 106, an air scouring step 108 and a tank drain step 110. These steps form a cycle which is repeated for continued filtration. Each step will be described in greater detail below.

In the filling step 100, a feed pump 12 pumps feed water 14 from the water supply 16 through the inlet 18 to the tank 20 where it becomes tank water 22. The tank 20 is filled when the level of the tank water 22 completely covers the membranes 24 in the tank 20.

During the balanced permeation step 102, drain valves 40 remain closed. The permeate valve 34 and an outlet valve 39 are opened and the permeate pump 32 is turned on. A negative pressure is created on the permeate side of the membranes 24 relative to the tank water 22 surrounding the membranes 24. The resulting transmembrane pressure draws tank water 22 (then referred to as permeate 36) through the membranes 24 while the membranes 24 reject solids which remain in the tank water 22. Thus, filtered permeate 36 is produced for use at the permeate outlet 38. Periodically, a storage tank valve 64 may be opened to admit permeate 36 to a storage tank 62 for use in backwashing. As filtered permeate 36 is removed from the tank, the feed pump 12 is operated to keep the tank water 22 at a level which covers the membranes 24 such as the tank full level or a design fill level. Foam or other substances may be occasionally removed, but there is generally dead end filtration. The balanced permeation step 102 may continue for between 15 minutes and three hours or between 15 minutes and 40 or 45 minutes or between 45 minutes and 90 minutes. Particularly if the balanced permeation step 102 is 45 minutes or longer, there may be intermediate aeration or backwashing steps within the balanced permeation step 102. During the balanced permeation step 102, the membranes 24 may be backwashed or air scoured from time to time prior to the permeate down step 104 or deconcentration steps of the process, and the balanced permeation step 104 continues during or after such intermediate air scouring or backwashing procedures.

In the permeate down step 104, the permeate pump 32 continues to run but the feed pump 12 is slowed down or, optionally, stopped. As a result, permeate 36 is produced but the level of the tank water 22 lowers. The tank water 22 may be lowered to the top of the highest part of a membrane 24 or to a point where a portion of the membranes 24 are exposed to air. Depending on the configuration of the membranes 24 or elements 8, exposing a portion of the membranes 24 to air may mean that the level of tank water 22 is below some entire membranes 24 or elements 8 but above others, or that the level of the tank water 22 is below a part of one or more membranes 24 or elements 8 but above other parts of the same membranes 24 or elements 8. The exposed portion of the membranes 24 may also be all of the membranes 24, particularly if upper membranes 24 may be isolated from the permeate pump 30.

Reducing the level in the tank 20 may temporarily reduce the maximum operating transmembrane pressure and therefore may in some cases cause a temporary reduction in permeate flow. However, the benefit of the reduced filtration cycle time may outweigh this temporary reduction in flow. Permeating while a portion of the membranes 24 are exposed to air also draws some air into the permeate 36. This air is collected in the air collectors 70 and discharged from time to time and, with sufficiently large air collectors 70 in relation to the amount of air pulled in, does not interfere with other aspects of the apparatus or process. However, to avoid drawing extremely large amounts of air into the permeate collectors 70, the transmembrane pressure during the permeate down step 104 may be kept below the bubble point of the membranes 24 without defects and the area of membranes 24 exposed to air while connected to the permeate pump 32 may be limited to no more than 50% of the total membrane area in the tank 20. The amount of air collecting in the air collectors 70 during the permeate down step 104 is monitored. If the amount of air collected over time exceeds a reasonable amount based on diffusion through wet pores, then a defect in the membranes 24 is indicated and they are tested and serviced if necessary.

To end the permeate down step 104, the permeate pump 32 and feed pumps 12 are turned off and the permeate valve 34 and outlet valves 39 are closed. Feed pump 12, if operating, may be stopped.

In the backwash step 106, with drain valves 40 closed if not also draining the tank 20, backwash valves 60 and storage tank valve 64 are opened. Permeate pump 32 is turned on to push filtered permeate 36 from storage tank 62 through a backwash pipe 63 to the headers 26 and through the walls of the membranes 24 in a reverse direction thus pushing away some of the solids attached to the membranes 24. The volume of water pumped through the walls of a set of the membranes 24 in the backwash may be between 10% and 40%, more often between 20% and 30%, of the volume of the tank 20 holding the membranes 24. At the end of the backwash, backwash valves 60 are closed. As an alternative to using the permeate pump 32 to drive the backwash, a separate pump can also be provided in the backwash line 63 which may then by-pass the permeate pump 32. By either means, the backwashing continues for between 15 seconds and one minute after which time the backwash step 106 is over. Permeate pump 32 is then turned off and backwash valves 60 closed.

The flux during backwashing may be 1 to 3 times the permeate flux and causes the level of the tank water 22 to rise. The reduction in water level during the permeate down step 104 and the increase in water level during the backwashing step 106 may be made such that the membranes 24 are fully immersed by the end of the backwash step 106. For example, the membranes 24 may be fully immersed for a subsequent aeration step 108. This reduces the volume of tank water 22 to be discharged to deconcentrate the tank 20 when compared to a process in which the membranes 24 are backwashed after balanced permeation and the tank is then drained. Alternately, the reduction in water level in the permeate down step 104 may exceed the increase in water level in backwash step 106 such that a portion of the membranes 24 remain exposed to air at the end of the backwash step 106. This further decreases the volume of water discharged and time used during the tank drain step 110. However, the aeration step 108 may be made less effective and so the aeration step may be moved to, or another aeration step 108 added, after or during the end of the balanced permeation step 102, between the balanced permeation step 102 and the permeate down step 104 or during the start of the permeate down step to include a time while the membranes 24 are fully immersed.

In the air scouring step 108, scouring air is provided by operating the air supply pump 50 to produce bubbles from aerators 56 located below, between or integral with the elements 8 or cassettes 28 corresponding to a superficial velocity of air flow between 0.005 m/s and 0.15 m/s for up to two minutes. This extended period of intense air scouring scrubs the membranes 24 to dislodge solids from them and disperses the dislodged solids into the tank water 22 generally. At the end of the air scouring step 104, the air supply pump 50 is turned off. Although shown after the backwash step 106, the air scouring step may also be provided before, during or between any of steps 104 to 110. Although the air scouring step 108 is most effective while the membranes 24 are completely immersed in tank water 22, it is still useful while a portion of the membranes 24 are exposed to air. The air scouring step 108 may also be more effective when combined with backwashing. For example, the air scouring step 108 may start at generally the same time as the backwash step 106 and stop when, or after, the backwash step 106 stops. In this way, air scouring occurs while backwashing when air scouring is most effective for a given water level.

For feed water 14 having minimal fouling properties, air scouring as part of the deconcentration step is all that is required. For some feed waters having more significant fouling properties, however, gentle air scouring may also be provided during the balanced permeation step 102 or permeate down step 104 to disperse the solids in the tank water 22 near the membranes 24. This gentle air scouring is to prevent the tank water 22 adjacent the membranes 24 from becoming overly rich in solids as permeate is withdrawn through the membranes 24. Accordingly, such air scouring is not considered part of the air scouring step 108 in the cycle of FIG. 5. For gentle air scouring, air may be provided continuously at a superficial velocity of air flow between 0.0005 m/s and 0.015 m/s or intermittently at a superficial velocity of air flow between 0.005 m/s and 0.15 m/s.

In the draining step 110, the drain valves 40 are opened to allow tank water 22, then containing an increased concentration of solids and called retentate 46, to flow from the tank 20 to through a retentate outlet 42 to a drain 44. The retentate pump 48 may be turned on to drain the tank more quickly, but in many installations the tank will empty rapidly enough by gravity alone. The draining step 110 can be started after all of steps 104, 106 and 108 are complete or can alternately be started while any of steps 104, 106 or 108 are ongoing or while a portion of the membranes 24 are exposed to air. In most industrial or municipal installations it typically takes between two and ten minutes and more frequently between two and five minutes to drain the tank 20 completely from full and less time when the water level has already been reduced.

In alternate embodiments of processes having a permeate down step 104, some of the steps described above in relation to FIG. 5 are performed in different orders or more than once. For example, after the permeate down step 104, the tank drain step 110 may be performed before the backwash step 106. A second tank drain step 110 may then be added after the backwash step 106 or the drain valves 40 may be left open so that the tank drain step 110 continues during the backwash step 106. The backwash step 106 and tank drain step 110 may also occur generally or partially at the same time. In these methods, total time required for the tank drain step 110 may be reduced although the aeration step 108 may need to be relocated, supplemented or made longer.

In other alternate embodiments, after the backwash step 106, a second permeate down step 104 may be performed before the tank drain step 110. This further reduces the volume of water discharged during the tank drain step. The second permeate down step 104 may continue for part or all of the tank drain step 110. If the second permeate down step 104 is continued until the tank is empty, monitoring the rate of air collection in the air collectors 70 provides a test of the integrity of all of the membranes 24.

In another alternate embodiment, the order of the permeate down step 104 and backwash step 106 are reversed. Thus, after the balanced permeation step 102, the water level is increased with a backwash step 106. This requires a tank 20 with increased freeboard, but also increases the available transmembrane pressure (TMP) for the permeate down step 104. The tank water 22 is also diluted of solids by the backwash step 106 which may reduce fouling of the membranes 24 during the permeate down step 104. The air scouring step 108 can also be performed during the backwash step 106 with the membranes 24 fully immersed in tank water for the entire backwash step 106. This may provide for a very effective air scouring step 108.

In another alternate embodiment, the tank drain step 110 is performed after the permeate down step 104. The backwash step 106 is performed after the tank drain step 110 and becomes part of the filling step 100 of the next batch. By this embodiment, solids pushed off of the membranes 24 during the backwash step 106 do not leave the tank until the tank drain step 110 of the next cycle. However, the volume of water discharged is made very small for a given length of the permeate down step 104. The air scouring step 108 is performed before or during the permeate down step 104, during the backwash step 106 or before or after the balanced permeate step 102.

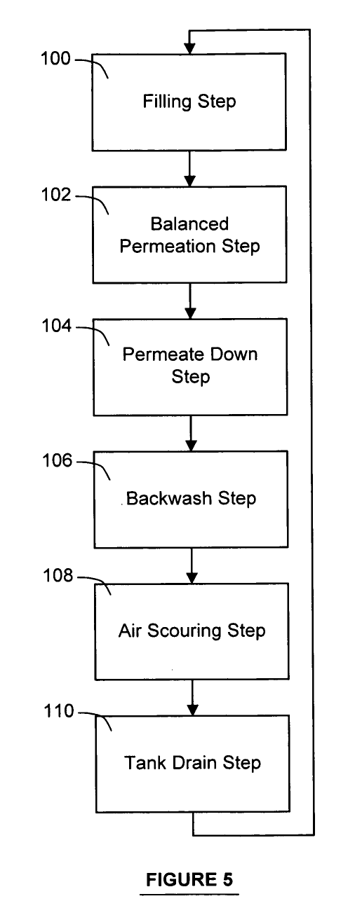

FIGS. 6 and 7 show a second reactor 111. The second reactor 111 differs from the reactor 10 in having an overflow area 112 in communication with each of three tanks 20 through an opening 114 which may be a pipe, a gate or an overflow area, such as a weir, and a return valve 116 operable to open and close an opening or pipe between the overflow area 112 and each tank 20. The openings 114 are located above a normal permeating level A and allow water to flow from a tank 20 to the overflow area 112 when the water level is at an increased level B in that tank 20. The return valves 116, when open, allow water to return from the overflow area 112 to the membrane tanks 20. Although three membrane tanks 20 are shown, there could be other numbers, for example between 1 and 10, connected to a single overflow area 112. Each tank 20 has all of the elements shown for the reactor 10 of FIG. 1 associated with it, although these items are not shown to simplify the illustration. Each tank 20 may be deconcentrated separately from the other tanks or all tanks 20 may be deconcentrated at the same time if the overflow area 112 is made larger than illustrated as required.

Each tank goes through a filtration process cycle. However, the timing of these cycles may be staggered between tanks 20 so that only one tank 20 requires use of the overflow area 112 at a time. In this way, the overflow area 112 can be sized for one tank 20 rather than for all tanks 20 in the second reactor 110.

The process for each tank 20 starts with a filling step 100 as described above. This is followed by a balanced permeation step 102 with the water level above the cassettes 28 but below the overflow 114, for example at line A shown. Return valve 116 is closed. After balanced permeation, a backwash step 106 is performed. This causes water from the tank 20 to rise, for example to level B, and to overflow into the overflow area 112. Return valve 116 may be open or closed during this step. If return valve 116 is kept open during this step, overflow 114 may be omitted or replaced with a wall extending above level B. After backwash step 106, a permeate down step 104 is performed. Return valve 116 is open during this step to allow water in the overflow area 112 to return to the tank 20. The permeate down step 104 may continue until a desired water level in the tank 20 is achieved, for example level C or another level below water return valve 116, although a level above return valve 116 may also be chosen. A draining step 110 is then performed, followed by a return to the filling step 100 of the next cycle, the filling performed with either feed water or a second backwashing. Return valve 116 is closed before filling step 100. An air scouring step 108 may also be provided at one or more times before or during the process, for example during the backwash step 106. This process provides advantages in that a volume of water less than the volume of the tank 20 is discharged during the draining step 110, that an air scouring step 108 may be performed with the cassettes 28 fully immersed and being backwashed, and that a portion of most of the permeate down step 104 may be performed with the water in the tank 20 diluted with backwashed permeate. This dilution counters the fact that the permeate down step 104 is performed after the backwash step 106 and in the presence of solids released during backwashing.

In all of the processes described above having a permeate down step 104, the tank 20 may be drained sufficiently to substantially deconcentrate the tank 20 for the next cycle. For example, in the last tank drain step 110 before the filtering step 100 of the next cycle, the tank 20 may be drained to a level that is 40% less, or 10% less, of the full level or design fill level, or to empty. The concentration of solids may be reduced such that the next cycle begins with a concentration of solids that is 40% or less than the concentration of solids at the end of the balanced permeation step 102.

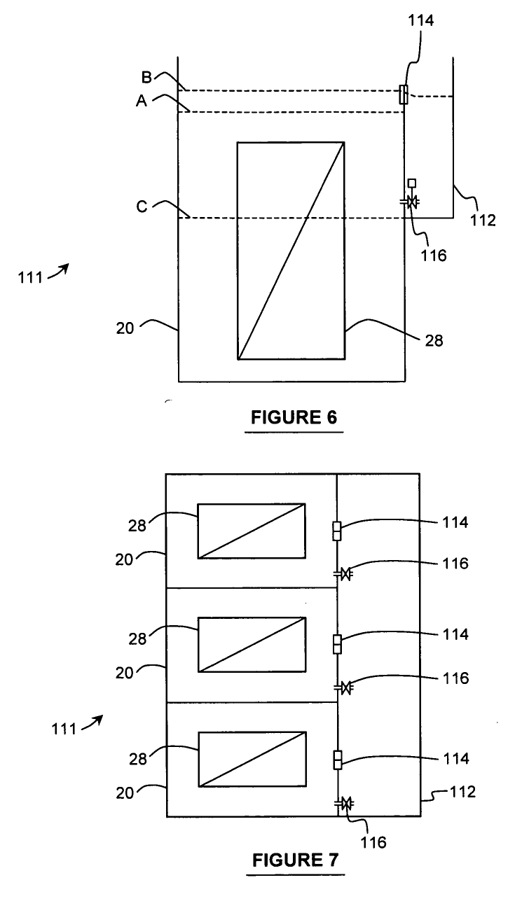

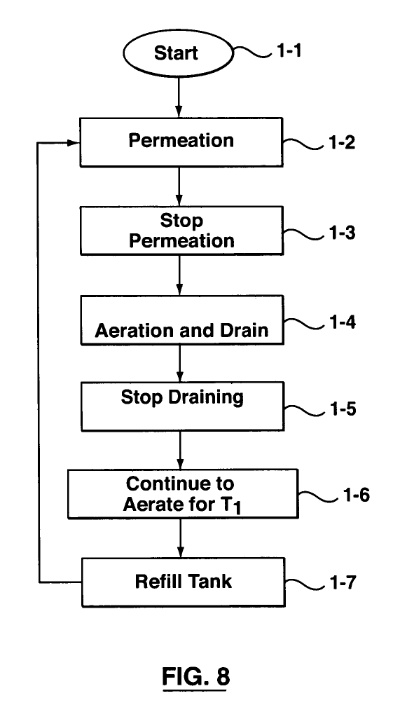

Additional or modified processes are described below in relation to FIGS. 8 and 9. Although these processes may be used with any type of membrane unit, they are particularly useful for hollow fiber membranes 24 oriented vertically between upper and lower headers 26, or membranes 24 extending upwards from a lower header 26 only. Immersed hollow-fiber membrane filtration systems sometimes encounter process problems as a result of solids accumulation in and around the membranes 24. The solids can accumulate to the point where they begin to dewater and form a mud-like substance known as sludge. In some modules, solids or sludge tends to accumulate primarily in certain locations, for example directly above the lower header 26 in a module of vertical fibers having either a top header or loose upper ends of the fibers. In some embodiments of the invention there is provided a process for removing solids from the fibers to substantially prevent the accumulation of sludge build-up on the fibers or clean fibers that have been fouled by a substantial sludge build-up.

Referring now to FIG. 8, a process is illustrated in a flow chart. This process provides for a partial tank drain, and thus a partial deconcentration effect, while still providing effective aeration, particularly for the lower part of the membranes 24, where aeration may be most critical, and allowing aeration and draining to be partially simultaneous. The process includes an initialization step 1-1, a permeation step 1-2, a stop-permeation step 1-3, a drain and aeration step 1-4, a stop draining step 1-5, a continued aeration step 1-6 and a tank refill step 1-7. These steps may be performed solely for the purpose of cleaning the membranes, may be integrated with another process involving further draining of the tank or may be used to form all or part of a cycle of concentration and deconcentration that is repeated frequently during the batch operation of a filtering system. Each step will be described in greater detail below with reference to FIGS. 1-4, 10 and 11.

In the initialization step 1-1, a feed pump 12 pumps feed water 14 from a water supply 16 through an inlet 18 to a tank 20 where it becomes tank water 22. The tank 20 is filled when the level of the tank water 22 completely covers one or more membranes 24 in the tank 20.

During the permeation step 1-2, permeate 36 is withdrawn from the tank 20 through the membranes 24. Drain valves 40 may be closed. The permeate valve 34 and an outlet valve 39 are opened and the permeate pump 32 is on. A negative pressure is created on the permeate side of the membranes 24 relative to the tank water 22 surrounding the membranes 24. The resulting transmembrane pressure draws tank water 22 (then referred to as permeate 36) through the membranes 24 while the membranes 24 reject solids that remain in the tank water 22. Thus, filtered permeate 36 is produced for use at a permeate outlet 38. Periodically, a storage tank valve 64 may be opened to admit permeate 36 to a storage tank 62. As filtered permeate 36 is removed from the tank, the feed pump 12 is operated to keep the tank water 22 at a level which covers the membranes 24.

The permeation step 1-2 may continue for between 15 minutes and three hours or longer, between 15 minutes and 40 or 45 minutes or between 45 minutes and 90 minutes per cycle. Particularly if the permeation step 1-2 is 45 minutes or longer, there may be intermediate backwashing or aeration steps within the permeation step 1-2. During the permeation step 1-2, solids may accumulate in the tank water 22 and permeability of the membranes 24 may decrease as the membranes 24 foul. The end of the permeation step may be determined by the membranes 24 dropping to a preselected permeability, by a duration of time having elapsed, by a time or a time and day having been reached, by an amount of permeate having been produced or other means. At this time, the permeation step 102 is ended. In the stop permeation step 1-3, the permeate pump 32 and feed pumps 12 are turned off and the permeate valve 34 and outlet valves 39 are closed.

At step 1-4, the cleansing process begins with an initialization of draining of the membrane tank 20, and starting aeration as well. Optionally, the start of aeration may precede the start of the tank drain, or the start of the tank drain may precede the start of aeration, although it is preferred if aeration is started at least by the time the liquid level is at or near the top of the module 28.

In order to drain the membrane tank 20, the drain valves 40 are opened to allow tank water 22, then containing a high concentration of solids and called retentate 46, to flow from the tank 20 through a retentate outlet 42 to a drain 44. The retentate pump 48 may be turned on to drain the tank more quickly, but in many installations the tank will empty rapidly enough by gravity alone. In most industrial or municipal installations it may ordinarily take between two and ten minutes, and more frequently between two and five minutes, to drain the tank 20 completely. Aeration continues during draining.

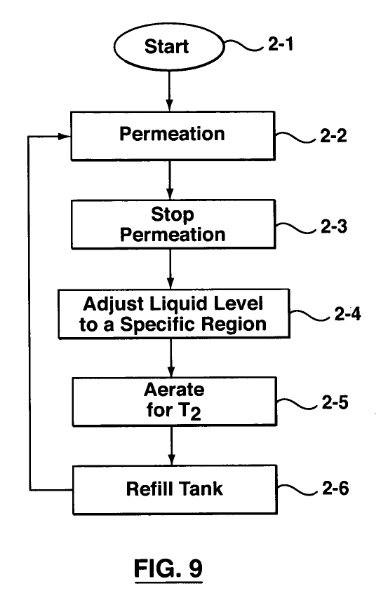

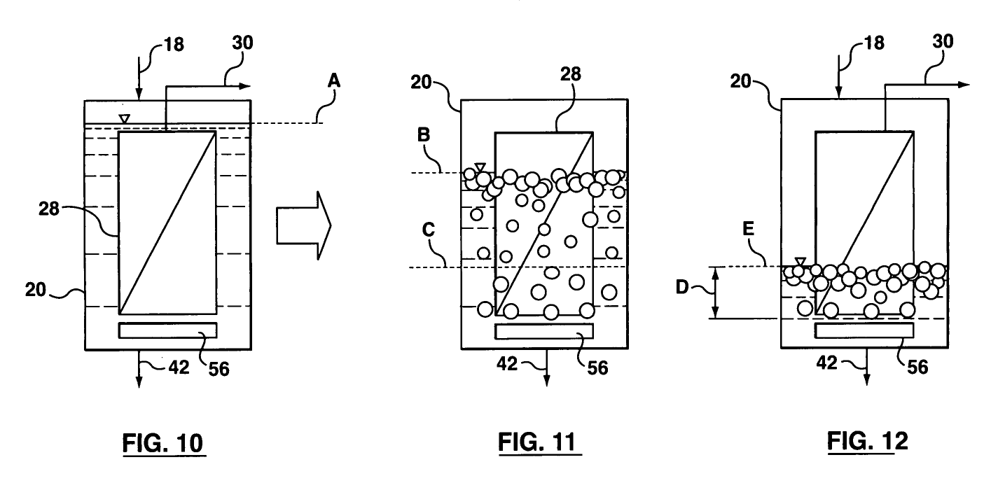

Referring to FIG. 10, the tank water 22 is shown above the membrane module 28 at a level A before step 1-4. Subsequently, as shown in FIG. 11, a lower level B illustrates an intermediary level of the tank water 22 as it is draining during step 1-4. As the tank 20 drains, the solid-liquid interface, with bubbles bursting at it, passes across a portion, which may be up to 50% or more, for example between 10 and 30%, of the surface area of the membranes 24. During this time, aeration is also effective on the immersed part of the membranes. At step 1-5 draining is paused or stopped at the level C, which may be near the top of the approximate level of a region where sludge accumulation is known or suspected to occur on the membranes 24. This allows the energy of bursting bubbles to scour an effective area near the liquid-air interface preferably including an area known to have sludging problems. Alternately, level C may be at a level, for example a level between 70 and 90% of the fill level or design level, that requires less draining to reach and keeps a larger portion of the membrane module 28, including the bottom of the membrane module, immersed. Optionally, draining may also be paused or stopped at one or more additional levels corresponding to regions where sludge accumulation is known or suspected to occur.

Aeration in steps 1-4 or 1-5 is provided by an aeration system 49 having an air supply pump 50 which blows air, nitrogen or other appropriate gas from an air intake 52 through air distribution pipes 54 to one or more aerators 56 located generally below the membrane modules 28 which disperse air bubbles 58 into the tank water 22. The rate of aeration may be between 10 and 60 delivered cfm per square meter of area, in plan view, of a module 28. The air bubbles 58 scour the portion of the membranes 24 that they pass and rise to the air-liquid interface where they burst, releasing energy and causing turbulence in the tank water 22.

Optionally, backwashing may also occur during or between any of steps 1-2 to 1-7 or at two or more of these times. For example, backwashing may be provided for about 30 seconds within step 1-6, or between steps 1-3 and 1-4. Two types of backwashing may be used—permeate or chemical as described in general in relation to FIGS. 1 to 4.

As indicated at step 1-6, the aeration continues at level C during the period of time T₁ which may be in the range of 30 seconds to 20 minutes. Subsequently, membrane tank 20 is refilled at step 1-7. Optionally, some or all of the remainder of the tank 20 may be drained before step 1-7 to dislodge sludge and further deconcentrate the tank 20. Aeration may remain on while the tank 20 is drained further. Alternatively, the dislodged sludge may be removed during a later deconcentration, repetition of steps 1-3 to 1-7 or retentate bleed. Since this method may be used to provide at least some aeration to the entire surface area of the membranes 24, this method may be used to replace other aeration steps that would otherwise be used in a process. T₁ may be chosen depending on how frequently the method is performed. For example, the method may be performed between 2 to 100 times a day and once a week, in which case T₁ is chosen more to prevent large sludge build ups from occurring rather than to remove an existing sludge build up and may be between 30 seconds and 5 minutes. If the method is performed less frequently, for example between once a day to twice a week and once every two months, T₁ maybe larger, for example between 2 minutes and 20 minutes. For example, if level C is between 70% and 90% of the full level or design level, the method may be performed in cycles of 3 hours or less with the drain valves 40 closed during the permeation step 1-2. In this case, the partial tank draining resembles a discontinuous bleed or a partial deconcentration with each cycle. T₁ may be 2 minutes or less, since step 1-6 is frequent. If level C is lower, for example near a lower header 26, the method may be performed with a longer cycle time and drain valves 40 may be open continuously or periodically during permeation steps 1-2, or step 1-2 may contain intermediate aeration, backwashing or deconcentration events, to provide a generally feed and bleed or batch process that is interrupted periodically. In this case, T₁ may be longer, for example up to 20 minutes or between 2 minutes and 20 minutes. T₁ may also be long, for example between 2 minutes and 20 minutes, when the process provides a periodic, for example between once a day and once a month, interruption to another process described herein.

As bubbles rise through tank water 22, they create turbulence and shear forces on the surface of the membranes 24, which control fouling and sludging to some extent. It has also been found by the inventors that when the bubbles reach the liquid-air interface, which is typically above the membrane fibers during permeation, they release a surprising amount of energy when they burst at the liquid-air interface. In some embodiments of the invention, the energy released by bursting bubbles at the liquid-air interface is employed to prevent fouling of membrane fibers and/or cleanse fouled membrane fibers. In such embodiments, a process for preventing and/or cleaning away sludge involves adjusting the water level to a level near where extensive membrane fouling and/or sludge build-up is observed and aerating for a period of time, such that the energy released at the liquid-air interface may act on the sludge, before refilling the membrane tank and continuing permeation or continuing to drain the tank fully. Adjusting the water level to specific areas provides those specific areas with the enhanced scouring that results from the bursting bubbles at the liquid-air interface. Typically, the specific areas targeted will be those areas prone to experiencing sludge build-up, such as the area directly above a lower header of a membrane unit with or without a top header or, to a lesser extent, directly below an upper header. This type of prevention and/or cleansing process is beneficial in reducing the amount of sludge that may otherwise accumulate on membrane fibers or removing sludge that has accumulated. Moreover, this type of prevention and/or cleansing process may allow membrane filters to be employed in conditions where severe and detrimental sludging can occur.

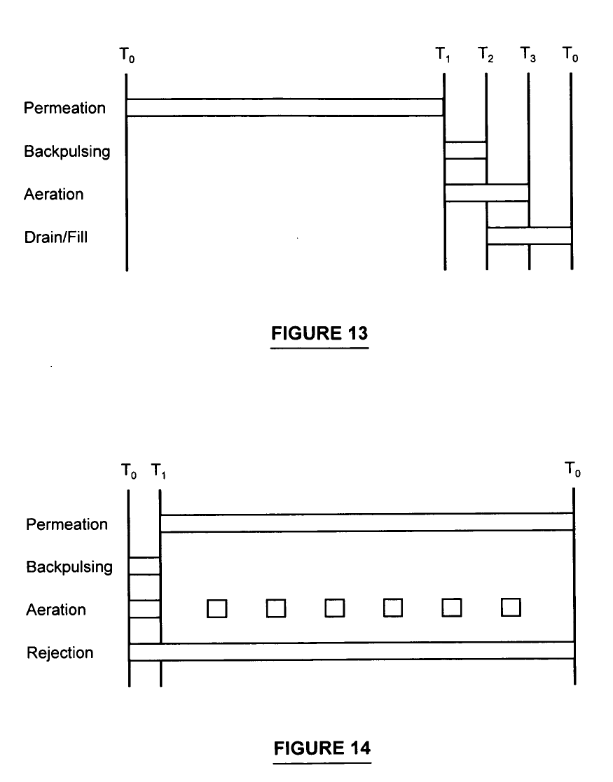

Referring now to FIG. 9, a second process for preventing fouling or cleansing membrane fibers within a membrane tank 20 is illustrated in a flow chart. The process includes an initialization step 2-1, a permeation step 2-2, a stop-permeation step 2-3, a liquid level adjustment step 24, an aeration step 2-5, and a membrane tank refill step 2-6. These steps may be performed solely for the purpose of cleaning the membranes, may be integrated with another process involving draining the tank or may be used to form all or part of a cycle of concentration and deconcentration that is repeated frequently during the batch operation of a filtering system. Each step will be described in greater detail below with reference to FIG. 12 and continued reference to FIGS. 1-4.

Steps 2-1 to 2-3 are identical to steps 1-1 to 1-3, respectively, that were described above with respect to FIG. 8. Other aspects of the method of FIG. 9 are also the same as, or similar to, the method of FIG. 8 and so will not be repeated. With reference to FIG. 12, starting at step 2-4, the liquid level in the membrane tank 20 is lowered to a level E at, or near the top of, an area where sludge may accumulate. Level E, or Level C in some embodiments of FIG. 11, may be within 30 cm of the bottom of the membranes 24, for example within 30 cm of the top of the lower header 26 of a module 28 of vertical fibers or within 20 cm or 15 cm of a bottom header 26 or only header 26 of a module 28 of vertical fibers 24. Modules 28 of other configurations may have other areas where sludge may accumulate.

At step 2-5, aeration is provided for a period of time T₂, which may be in the range of 30 seconds to twenty minutes. The bursting bubbles provide enough turbulence to effectively scour the membrane fibers a depth D below the liquid-air interface at level E. This depth is dependent on the intensity of the aeration and in the present example it may be up to 30 cm below level E and/or sufficient to reach the bottom of the membranes 24 or the top of a lower or only header in a module with vertical fibers. Steps 2-4 and 2-5 may be repeated one or more times at different liquid levels if there are multiple areas of the module 28 prone to sludging or solids build ups. After the last aeration step 2-5, the membrane tank is refilled at step 2-6 optionally after further or fully draining the tank to immediately remove the dislodged sludge. Because this method does not provide aeration for the entire surface area of the membranes, this method may be used when another aeration step affecting the entire membrane surface area is provided during another part of the process, for example during step 2-2 or between steps 2-3 or 2-4. The precise duration of T₂ may be the same as, and chosen as described for, T₁. In either method, T₁ or T₂ may also be variable or the methods may be combined. For example, the method of either FIG. 8 or FIG. 9 may be performed frequently with a short T₁ or T₂ while, in the same process, the method of either FIG. 8 or FIG. 9 is additionally performed less frequently and with a larger T₁ or T₂.

Other modifications to these processes may also be practiced. For example, the draining in step 1-4 or the liquid level adjustment in step 2-4 may be by permeating down as in step 104 of FIG. 5. Further, the tank water 22 may be a wastewater as well as water being filtered to provide drinking, municipal or process water. Further, the tank may be refilled after step 1-6 or 2-6 without draining below the pause level with the sludge removed later by concentrate bleed or in the next deconcentration, cleaning or tank drain. Further, the invention may be used with non-batch processes, for example by draining the tank in steps 1-4 or 2-4 to another reservoir and then refilling the tank from that reservoir or by performing the invention only as frequently as a drain of the tank can be tolerated or as required for other reasons.

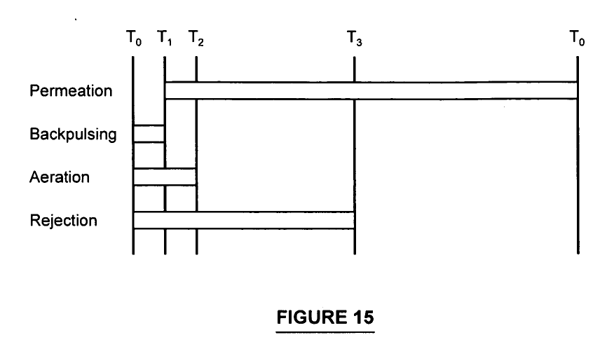

FIGS. 13 to 15 shown additional processes. Although designed to retrofit continuously aerated feed and bleed systems, the processes may also be applied to other or newly built systems.

FIG. 13 shows another a which is similar to, and may be practiced in some cases within the scope of, the process of FIG. 8. Permeation begins at T₀ and continues to T₁. The time between T₀ and T₁, which may be 15 to 40 or 45 minutes for example, may be dead end permeation without withdrawal of retentate. At T₁, permeation stops and backpulsing and aeration begin. Backpulsing and aeration continue for 15 seconds to 5 minutes or 30 seconds to 90 seconds until T₂. At T₂, backwashing stops and a partial drain or refill of the tank begins. During the drain/refill, a portion, for example between 5 or 10% and 25%, of the full or normal volume of tank water 22, for example the average or design volume of water present during permeation, is drained from the tank 20 and then replaced with fresh feed water 14. The amount removed may be related to a desired recovery rate. Parts of the membranes 24 may be exposed during these steps. These steps may take for example from 30 seconds to 5 minutes and end with T₀ at the start of the next cycle. Aeration may continue until a time T₃ occurring during the drain/refill step. Aeration may also be provided during the refill step of this process or in the fill step of any of the other processes described herein. Aeration may end before or at the start of refilling the tank 20. There may also be an aerated pause period between draining and refilling as in the process of FIG. 8, or the refill may begin immediately after the draining. Compared to a continuously aerated feed and bleed process, the process of FIG. 12 may allow a 90-95% reduction in the amount of aeration required while still handling medium to high solid loadings, for example a total suspended solids (TSS) of 1000 mg/L in the tank water 22 or retentate 46. Although the plant must be modified or built to provide for rapid partial drains and refill, the process requires less modification or drain and feed capacity than a batch process having a complete tank drain and refill steps. The process provides partial deconcentration and the drain occurs after or while solids are released from the membranes 24 by the backpulsing and aeration.

FIG. 14 shows another process. At T₀, the membranes are backwashed and aerated until T₁. The time between T₀ and T₁ may be about, for example 10 seconds to 60 seconds or about 15 seconds. The backpulse and aeration need not occur exactly at the same time, or for the same duration of time, as shown. At T₁, permeation and aeration for resuspension begin. As shown, the aeration may be intermittent, for example 5-20 seconds or about 10 seconds, every 1 to 4 minutes or about every 2 minutes at the regular aeration rate described previously. Alternately, continuous aeration at a reduced rate may be provided. A generally continuous bleed or reject is provided generally throughout the cycle. The cycles may last, for example for between 10 and 20 minutes or about 15 minutes.

Compared to a continuously aerated feed and bleed process, aeration may be reduced by about 80-85%. Only modifications to the aeration system are required. However, the process may result in reduced fluxes or occasional sludging of the membranes in medium or high solids concentration plants, although it may be adequate for low to medium solids concentration plants.

FIG. 15 shows another process. Backpulsing, aeration and rejection begin at T₀. Backpulsing stops, for example after 10-30 seconds or, about 15 seconds, at T₁ and permeation begins. Aeration continues until T₂, which may be, for example about 60-120 seconds or about 90 seconds after T₀. Reject removal continues until T₃. After T₃, reject removal stops while permeation continues to T₀ of the next cycle. T₃ is chosen to include a period after T₂ when the TSS concentration in the reject remains elevated due to the backpulsing and aeration, which may be, for example about 5 to 10 minutes or about 7.5 minutes after T₀. The rate of reject removal may be chosen, or T₃ extended, to achieve a desired volumetric removal of retentate. Alternately, if reject removal until T₃ does not remove enough volume of tank water, rejection may begin again prior to T₀. The total cycle time may be, for example about 10-20 minutes or about 15 minutes and reject may be withdrawn for, for example about ⅔ or ½ or less of the duration of the cycle. The amount of retentate 46 removed per cycle may be between 5 and 25% or 5 and 10% of the volume of the tank 20. The rate of reject 46 removal may be 10-20% of the average rate of permeate 36 removal. Averaged over an entire cycle, retentate 46 removal may be an amount producing a recovery rate between 80 or 90% and 95%. The rate of permeate 36 removal may be kept constant with the feed 14 input rate varied to keep a generally constant level of tank water 22 or to keep the tank water 22 level within an acceptable rate. Alternately or additionally, the tank water 22 level may be intentionally allowed to fluctuate to some degree, for example rising during the backwash and declining while retentate 46 is withdrawn and possibly further into the cycle.

Compared to a continuously aerated feed and bleed process, this method may reduce aeration by 80% or more. The plant or design must be modified to accept increased reject flow rates, for example 150% or twice or more of the design flow of a continuous bleed plant, but those modifications are less than for a batch process with full tank drainings. The process can handle medium to high solids loadings.

In the paragraphs above relating to FIGS. 13-15, comparisons with a continuously aerated feed and bleed process assume that the continuously aerated feed and bleed process uses aeration in a 10 seconds on 10 seconds off cycle throughout permeation. A low solids level has an after flocculation, if any, feed TSS of less than 5 mg/L. A high solids level has an after flocculation, if any, feed TSS of over 50 mg/L. A medium solids level is between these two, for example between 5 and 50 mg/L or between 5 and 25 mg/L.

The preceding description was of exemplary embodiments only and does not limit the scope of the invention, which may be practiced with various modifications.

We claim:

1. A reactor having a membrane tank with a membrane module and an overflow area, the overflow area being fluidly connected to the tank through a valved passageway from the bottom of the overflow area to the tank such that the overflow area can drain into the tank, the passageway located below the top of the membrane module.

2. The reactor of claim 1 having a passageway between the tank and the overflow area, the overflow located above the passageway and above the top of the membrane module.

3. A filtration process using membranes immersed in a tank comprising the steps of:
a) permeating; and,
b) after step (a), backwashing, aerating, partially draining the tank and refilling the tank,
wherein steps a) and b) are performed in repeated cycles.

4. The process of claim 3 wherein the step of permeating is dead end.

5. The process of claim 3 wherein 10-25% of the tank design volume or fill volume is drained in step b).

6. The process of claim 3 wherein the tank is partially drained to a level corresponding to an area of the membrane having an accumulation of solids and the membranes are aerated while the tank is held at that level.

7. A process according to claim 3 further comprising, after step (a) and before draining the tank, withdrawing permeate in excess of any feed water entering the tank.

8. The process of claim 3 further comprising providing aeration intermittently while permeating.

9. The process of claim 8 wherein aeration is provided while permeating for between 5 and 30 seconds every 1 to 5 minutes.

10. The process of claim 8 further comprising providing aeration while backwashing.

11. The process of claim 8 wherein step (b) occurs during step (a).

12. A filtration process comprising the steps of:
a) permeating;
b) after a), backpulsing;
c) during b) and extending into a portion of a), aerating; and,
d) during a portion of a), withdrawing retentate,
wherein the steps above are performed in repeated cycles.

13. The process of claim 12 wherein part of step d) is performed during 25-60% of step (a).

14. The process of claim 12 wherein part of step d) is performed during step b).

15. The process of claim 12 further comprising reducing the water level to below a portion of the membranes during steps (a) or (d).

16. The process of claim 12 wherein less than the tank design or fill volume is drained in step (d).

17. The process of claim 12 wherein 10-25% of the tank design or fill volume is drained in step (d).

18. The process of claim 12 wherein the process is a non-recirculating process.

19. The process of claim 12 wherein the cycle time is between 15 minutes and 40 or 45 minutes.

20. The process of claim 19 wherein the cycle time is 30 minutes or less
